(19) United States
(12) Patent Application Publication
(10) Pub. No.: US 2014/0342322 A1
(43) Pub. Date: Nov. 20, 2014

(54) Securing device for bound component

(71) Applicant: ACCO Brands Corporation, Chicago, IL (US)

(72) Inventors: Patrick B. Nolan, Royersford, PA (US); Noah E. Dingler, Phoenixville, PA (US); Michael A. Dotsey, Pottstown, PA (US)

(73) Assignee: ACCO Brands Corporation, Chicago, IL (US)

(21) Appl. No.: 14/120,295

(22) Filed: May 14, 2014

Related U.S. Application Data
(60) Provisional application No. 61/823,170, filed on May 14, 2013.

(51) Int. Cl. G09B 11/04; G09B 11/06

(52) U.S. Cl. CPC G09B 11/04; G09B 11/06
USPC 434/163

(57) ABSTRACT

A writing or display system including a case having an opening configured to receive an insert therein. The insert includes a plurality of pages bound together by a binding device, and the case includes a generally clear, transparent or translucent panel configured such that an outer-most page of the insert is viewable therethrough when the insert is received in the opening. The case further includes a coupling device configured to selectively engage the binding device or an outer surface of the pages to retain the insert in the case.

This application claims priority to U.S. Provisional Patent Application Ser. No. 61/823,170, filed on May 14, 2013, the entire contents of which are hereby incorporated by reference.

The present invention is directed to a device configured to be coupled to a bound component.

### BACKGROUND

Writing guides, such as templates and the like, are often used to teach writing, reading, drawing or other skills. However, such templates are often loose and difficult to properly position for children or other users with relatively low motor skills.

In addition, bound components, such as wire bound devices or the like, are often used in conjunction with other devices, such as binders, cases or the like. Therefore in some cases it may be desired to couple the bound components and devices together.

### SUMMARY

In one embodiment the present invention utilizes a case which can receive a bound component therein, where the case includes a coupling device to secure the bound component in place. More particularly, in one embodiment the invention is a writing or display system including a case having an opening configured to receive an insert therein. The insert includes a plurality of pages bound together by a binding device, and the case includes a generally clear, transparent or translucent panel configured such that an outer-most page of the insert is viewable therethrough when the insert is received in the opening. The case further includes a coupling device configured to selectively engage the binding device or an outer surface of the pages to retain the insert in the case.

A system including a bound system having a plurality of pages bound by a generally tubular binding device including an axially-extending opening. The system further includes a component including a protrusion movably mounted thereto. The protrusion is movable between an engaged position wherein at least part of the protrusion is received in the opening to couple the bound system to the component, and a retracted position wherein the protrusion is not received in the opening such that the protrusion does not couple the bound system to the component.

### BRIEF DESCRIPTION OF DRAWINGS

FIG. 1 is a front perspective view of a case and an associated insert, with the insert exploded away from the case;

FIG. 2 is a front perspective view of the case and insert of FIG. 1, with the insert received in the case;

FIG. 3 is a front perspective view of the case and insert of FIG. 2, with the coupling device in its engaged position;

FIG. 4 is a top view of the case and insert of FIG. 3, illustrating a user writing on a panel of the case;

FIG. 5 is a top view of the case with an alternate insert;

FIG. 6 is a top view of a case or cover including movable tabs; and

FIG. 7 is a top view of the case or cover of FIG. 7, with the tabs securing a bound system thereto.

### DETAILED DESCRIPTION

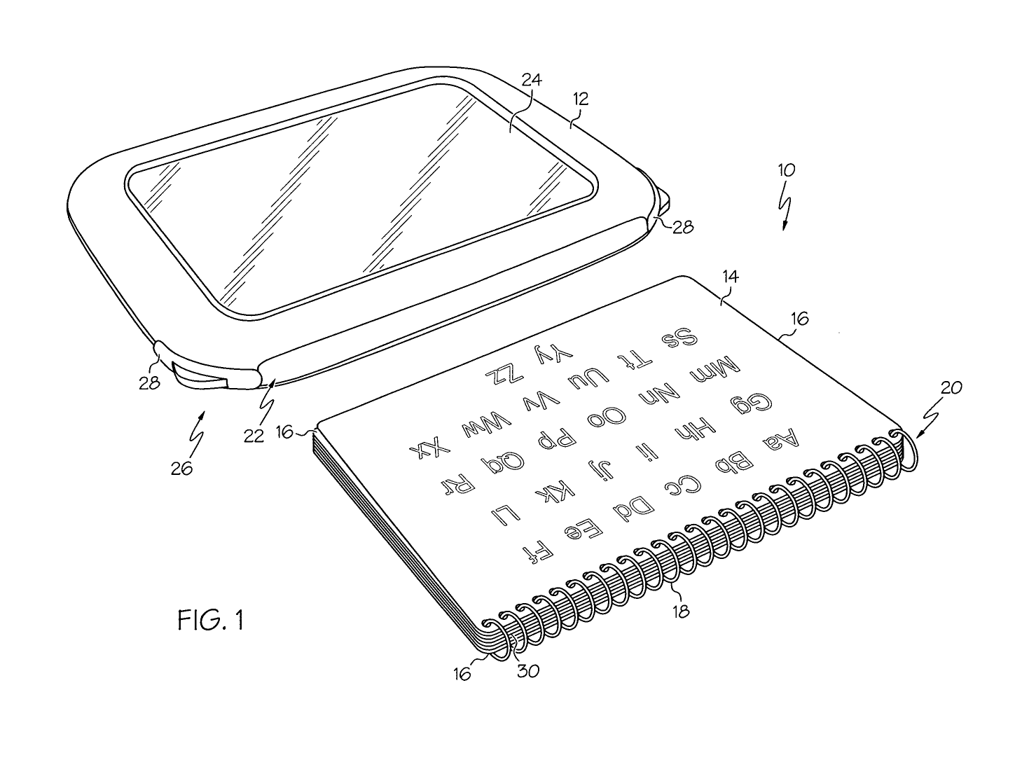

As shown in FIG. 1, in one embodiment the writing or display system, generally designated 10, includes a device, case or cover 12 (which can include a case or cover body) and an insert 14. In the embodiment shown in FIGS. 1-5 the case 12 is generally rectangular in top view and shaped somewhat as a rectangular prism. However, the case 12 can have a wide variety of shapes and take any of a wide variety of forms beyond those shown in the drawings.

The insert 14 can take the form of a bound component including a plurality of pages 16 bound together by a binding device or mechanism 18. The pages 16 can be made of any of a wide variety of materials, such as paper, cardboard, plastic or polymers, plastic-coated paper or cardboard, etc. Each of the pages 16 may include indicia printed thereon which can take any wide variety of forms and shapes, as described in greater detail below. However, in the embodiment shown in FIGS. 1-5, the indicia takes the form of the printed letters of the English alphabet.

Each of the pages 16 may be generally rectangular in top view, although the pages 16 can take any wide variety of others shapes and sizes. The pages 16 are pivotally mounted to the binding device 18. For example, FIG. 1 shows the upper-most page 16 pivoted slightly opened and spaced away from the underlying page 16. The insert 14 may include various covers, including front and/or back covers bound by the binding device 18, and for the purpose of this application such covers can also be considered to be bound pages 16.

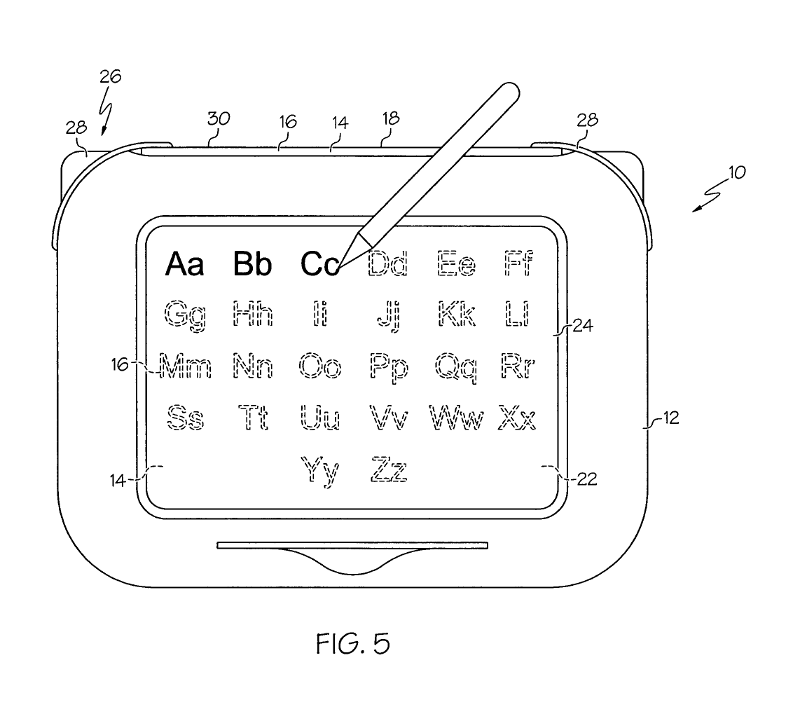

The binding device 18 takes the form of a spiral, coil or helical binding mechanism in the illustrated embodiment. In this case, the binding device 18 defines a generally tubular, or more specifically, cylindrical, shape having a central axially-extending opening 20. However, the binding device 18 can take any wide variety of other shapes and forms, including but not limited to a twin wire binding device, a polymer binding devices with curled fingers, etc., which could be circular or other shapes in cross section. Moreover, the binding device 18 need not necessarily include the cylindrical shape of a spiral or twin wire binding device and could, for example, take the form of an adhesive binding device 18 (shown in FIG. 5) or other forms, such as stitching, book-style bindings, etc. The opening 20 can extend the entire length of the binding device 18, or along only part of the length thereof, or be continuous or discontinuous.

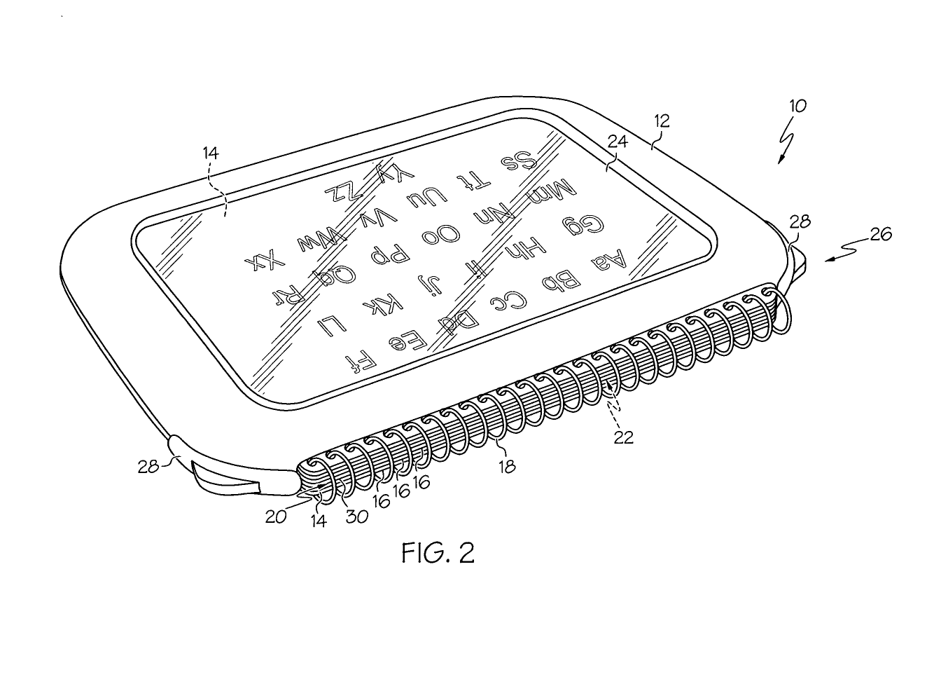

The case 12 includes an opening or cavity 22 configured to receive the insert 14 therein, and positioned along a longitudinal edge of the case 12 in the illustrated embodiment. The case 12 also includes a generally clear, transparent or translucent panel 24 on one of its major surfaces. As shown in FIG. 2, the panel 24 may be configured to be generally parallel with the insert 14 and/or a top page 16 thereof when the insert 14 is received in the case 12. The panel 24 can also have a size generally corresponding to that of the insert 14/outer-most page 16 and have, for example, a surface area at least about 90%, in one case, of the surface area of the insert 14/outer-most page 16, or have a surface areas within about 90% of each other, to enable viewing of the outer-most page 16 and use of the system.

The opening 22 can be sized to entirely, or generally entirely, receive the insert 14 therein. For example, as shown in FIGS. 2-4, in one case all of the insert 14, except for the binding device 18, can be received in the opening 22. Alternately, in one case the entire insert 14 can be received in the opening 22. In the embodiment shown in FIG. 5, in which an adhesive-style binding device 18 is utilized, the binding device 18 still remains outside of the opening 22, although in this case, too, the insert 14 (including the binding device 18) could be entirely received in the opening 22.

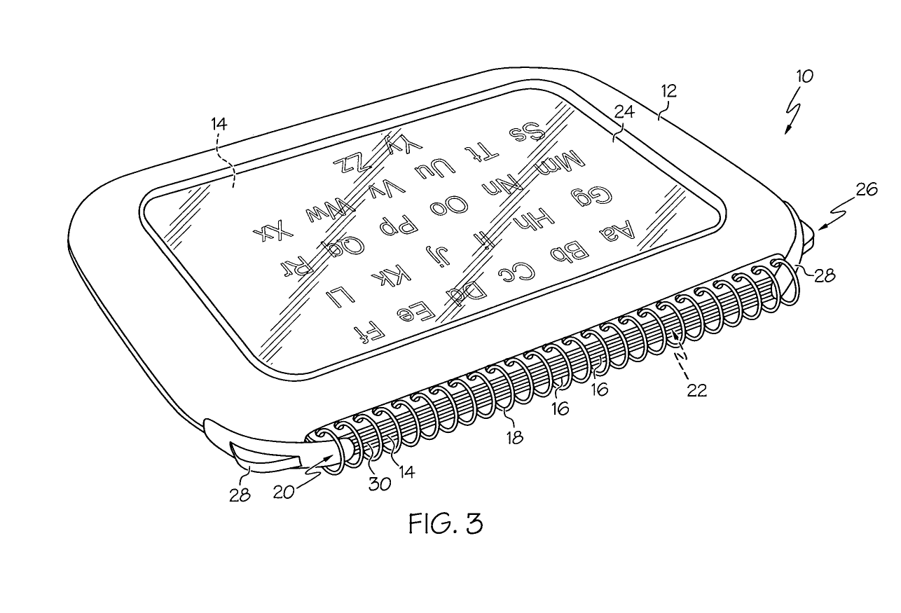

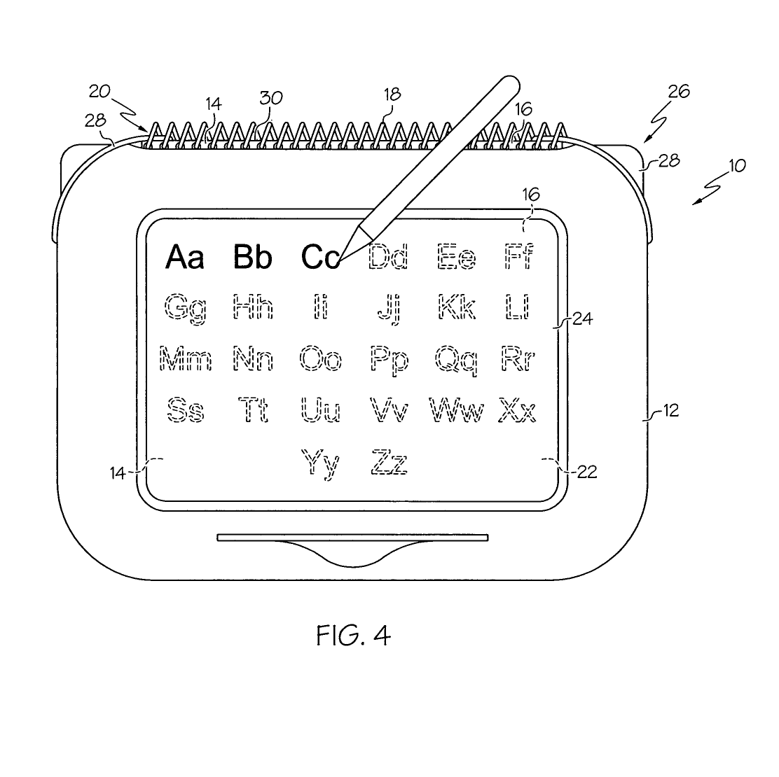

The case 12 includes a coupling device 26 configured to selectively engage the insert 14 (more particularly, in one case, the binding device 18 or an outer surface of the pages 16) to retain the insert 14 in position in the case 12/opening 22. In one embodiment the coupling device 26 takes the form of a pair of tabs or protrusions 28 positioned at opposite corners of the case 12, and at opposite axial ends of the opening 22. Each tab 28 is slidable, pivotable or otherwise moveable between a retracted or disengaged position (FIGS. 1 and 2) and an engaged position (FIGS. 3 and 4). When in the disengaged position, in one embodiment, the tabs 28 are entirely retracted from, and do not overlap with, the mouth of the opening 22, and/or do not engage the insert 14 to retain the insert 14 in place. When the coupling device 26/tabs 28 are in their engaged positions, the coupling device 26/tabs 28 can be positioned at least partially over the mouth of the opening 22 and/or part of the received insert 14, pages 16 and/or binding device 18 to retain the insert 14 in the case 12.

In the embodiment of FIGS. 1-4, an inner/distal end of each tab 28 is received in the central opening 20 of the binding device 18 to retain the insert 14 in place. In addition, the coupling device 26/tabs 28 may engage and/or be positioned immediately adjacent to the outer surface 30 (in the illustrated embodiment, the upper surface adjacent the binding device 18) of the insert 14/pages 16 to retain the insert 14 in place. In the embodiment of FIG. 5, the coupling device 26/tabs 28 are positionable immediately above/adjacent to the outer (upper) edge 30 of the pages 16 and/or outer (upper) edge 30 of the binding device 18 to retain the insert 14 in place. In addition, the tabs 28 may be able to engage various other portions of the insert 14 to retain the insert 14 in place. For example, in one case, the insert 14 and/or each page 16 may include a set of aligned notches along the sides thereof such that each tab 28 can be positioned in an associated notch to retain the insert 14 in place. Further alternately, the tabs 28 could be configured to engage the outer surface of the binding coil 18 to retain the insert 14 in place.

The tabs 28 can take of a wide variety of shapes and forms beyond those shown in FIGS. 1-5. For example, rather than being mounted on the corners, one or more tabs 28 can be mounted on the front and/or rear face of the case 12, in some cases adjacent to the opening 22. In one embodiment each of the tabs 28 are individually actuable, however, if desired the tabs 28 may be mechanically coupled such that actuation of one tab 28 automatically actuates the other. In addition, if desired, only a single tab 28 may be utilized.

As described above and shown in FIGS. 2-5, when the insert 14 is properly positioned in the case 12, indicia on the outer-most page 16 of the insert 14 is viewable through the panel 24. A user can then write on the panel 24, in one case using an erasable medium, such as dry-erase markers. As shown in FIGS. 4 and 5, a user can thereby trace over the underlying indicia provided by the insert 14 so that the insert 14 provides guidance, practice, instruction and/or exercise for a user such that a user can develop writing skills, drawing skills, fine motor skills, etc. Thus, the indicia printed on the pages 16 can take any of a wide variety of forms, including letters, words, sentences, geometric shapes, irregular shapes, full and/or partial drawings, dotted line drawings to be traced, connect-the-dots indicia, etc.

Accordingly, the panel 24 may be made of a surface which can receive dry-erase markings thereon which can be removed by wiping. Thus, in one case, the dry-erase markings can include a combination of pigments and release agents, wherein the release agents prevent the pigment particles from sticking to the panel 24. The writing from the dry-erase marker can thereby adhere to the panel 24 without binding or being absorbed by the panel 24. Thus, the panel 24 may be made of a non-porous surface such that the dry-erase markings can be easily wiped off in the manner of a standard white board.

The coupling device 26/tabs 28 provide an intuitive and easy-to-operate system for locking the insert 14 in place. When it is desired to utilize a new insert, or flip the pages of the existing insert 14, the tabs 28 are moved to their disengaged position, allowing the insert 14 to be removed and pages 16 flipped and/or replaced with another insert 14. The dry-erase nature of the panel 24 enables the panel 24 to be wiped clean such that it can be re-used repeatedly. The coupling device 28 enables a child or user with a low degree of motor skill to easily insert, secure and remove the insert 14.

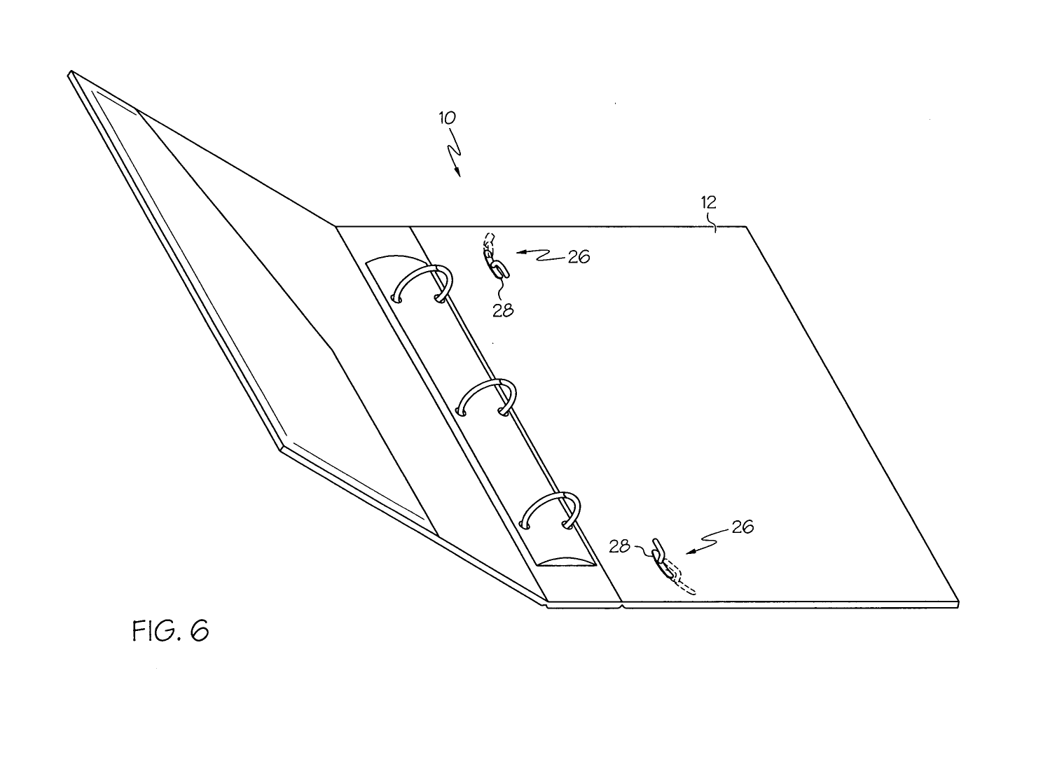

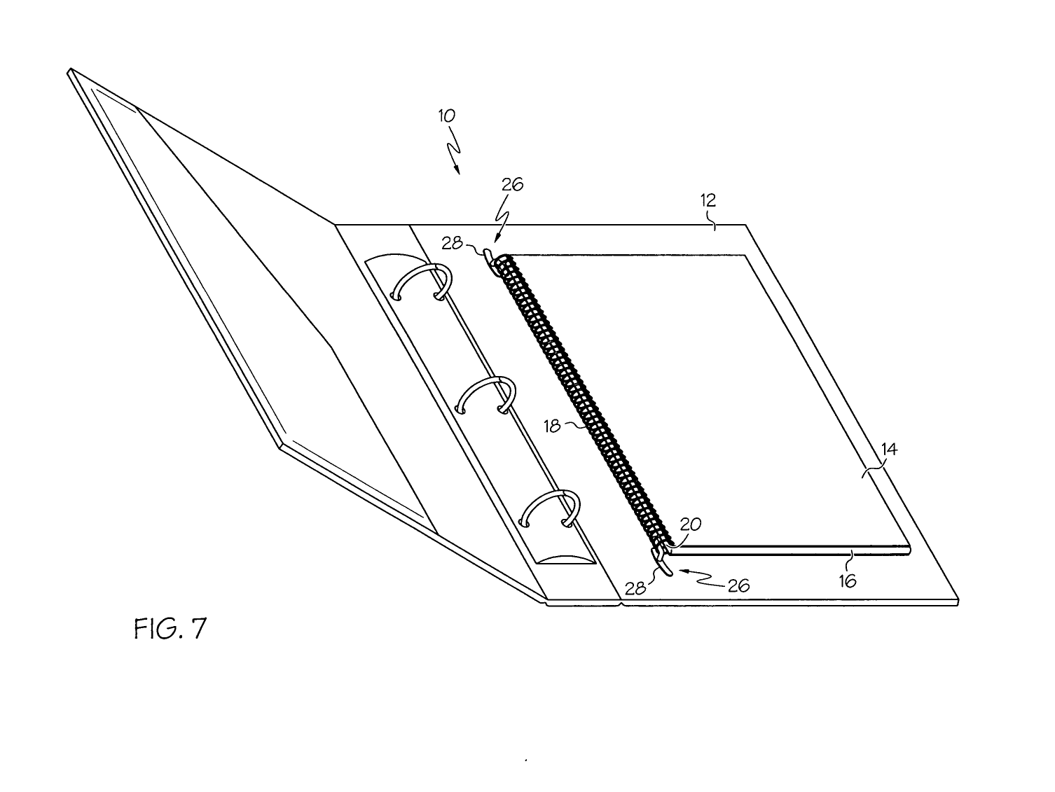

The coupling device 26 described herein can also be used in a variety of differing manners than that shown herein to provide associated advantages. For example, as shown in FIGS. 6 and 7, the component 12 can include or take the form of a case, or a cover, such as a cover for a three ring binder, bound component, bound system, or the like. The component 12 can also take the form of various other components, such as a single panel cover, a cover with multiple pivotable panels, etc. In FIGS. 6 and 7 the coupling device 26 (i.e. one or more tabs 28) can be mounted to the component, case or cover 12 and utilized in the manner described above to couple the bound system/insert 14 (which can take the form of a standard wire-bound notebook of papers sheets or the like, as shown in FIG. 7) to the component 12. In this case the component 12 may lack the opening 22, and the notebook/insert 14 is held in place by the tabs 28.

The tab(s) 28 can be slidably/movably mounted to one or more generally flat panels of the component 12 in a variety of manners. For example, each tab 28 can have a projection on the underside thereof that fit into a corresponding slot formed in the cover 12, or fits into a corresponding slot formed in a separate device or component coupled to the cover 12, or be pivotally mounted on a rivet, etc. The tabs 28 can be positioned in a variety of locations, such as on the inside and/or outside of the cover 12, or be aligned along the top, bottom or outer edge (instead of the inner edge shown in FIGS. 5 and 6), etc. The tabs 28 thus can be configured to engage the insert 14 to retain the insert 14 in a position wherein the insert 14 is coupled to, positioned within and/or covered by the component 12 (e.g. in one case the component 12 or a panel thereof has a surface area at least as large as a surface area of the bound system 14).

Having described the invention in detail and by reference to the various embodiments, it should be understood that modifications and variations thereof are possible without departing from the scope of the claims of the present application.

What is claimed is:

1. A writing or display system comprising:
a case including an opening configured to receive an insert therein, said insert including a plurality of pages bound together by a binding device, the case including a generally clear, transparent or translucent panel configured such that an outer-most page of said insert is viewable therethrough when said insert is received in said opening, the case further including a coupling device configured to selectively engage said binding device or an outer surface of said pages to retain said insert in said case.

2. The system of claim 1 wherein said binding device defines a generally cylindrical shape having a central opening.

3. The system of claim 2 wherein said binding device is a twin wire binding device or a spiral wire binding device.

4. The system of claim 2 wherein said coupling device includes a tab selectively positionable in said central opening when said insert is received in said case.

5. The system of claim 4 wherein said tab is configured to engage an outer surface of said pages when said tab is positioned in said central opening.

6. The system of claim 4 wherein said tab is movable between an engaged position in which at least part of said tab is received in said central opening when said insert is received in said case, and a disengaged position in which no part of said tab is received in said central opening when said insert is received in said case.

7. The system of claim 4 wherein said coupling device includes a supplemental tab selectively positionable in said central opening when said insert is received in said case.

8. The system of claim 7 wherein said tab and said supplemental tab are positioned at opposite axial ends of said binding device when said insert is received in said case.

9. The system of claim 7 wherein said tab and said supplemental tab are individually actuable.

10. The system of claim 1 wherein said coupling mechanism is configured to engage an outer surface of said binding device.

11. The system of claim 1 wherein said panel is made of a non-porous dry erase surface such that said panel can receive dry erase marking thereon in a manner that is viewable by a user, and such that said dry erase markings are removable by rubbing thereof.

12. The system of claim 1 further comprising said insert.

13. The system of claim 12 wherein said insert is received in said opening and said coupling device selectively engages said binding device or the outer surface of the pages to retain said insert in said case.

14. The system of claim 12 wherein said insert is entirely removable from said case such that another insert is positionable in said opening such that an outer-most page of said another insert is viewable through said panel.

15. The system of claim 12 wherein at least one of said pages include indicia thereon that is viewable through said panel, and wherein said panel includes indicia manually written thereon that generally corresponds to said indicia of said at least one of said pages.

16. The system of claim 12 wherein said panel has a surface area within 90% of a surface area of said pages such that said pages can be viewed therethrough.

17. The system of claim 12 wherein said opening is configured to receive all or substantially all of said insert therein.

18. A writing or display system comprising:
a case including an opening configured to receive an insert therein, said insert including a plurality of pages bound together by a binding device, the case including a generally clear, transparent or translucent panel such that an outer-most page of said insert is viewable therethrough when said insert is received in said opening, the case further including a coupling device configured to selectively engage said insert to retain said insert in said case.

19. A method for using a writing or display system comprising:
accessing a case including an opening, a generally clear, transparent or translucent panel, and a coupling device;
accessing an insert having a plurality of pages bound together by a binding device;
positioning said insert in said opening such that an outer-most page of said insert is viewable through said panel; and
operating said coupling device to engage said binding device or an outer surface of pages to retain said insert in said case.

20. The method of claim 19 wherein the outer-most page includes indicia thereon, and wherein the method further comprises manually making removable markings, on the panel, that correspond to the indicia.

21. A system comprising:
a bound system including a plurality of pages bound by a generally tubular binding device including an axially-extending opening; and
a component including a protrusion movably mounted thereto, wherein the protrusion is movable between an engaged position wherein at least part of said protrusion is received in said opening to couple said bound system to said component, and a retracted position wherein said protrusion is not received in said opening such that said protrusion does not couple said bound system to said component.

22. The system of claim 21 wherein the binding device is a spiral or twin wire binding device, and wherein the component includes or takes the form of a generally flat panel having a surface area at least as large as said bound system.

23. The system of claim 21 wherein said component includes a supplemental protrusion movably mounted thereto, wherein the supplemental protrusion is movable between an engaged position wherein at least part of said supplemental protrusion is received in said opening to couple said bound system to said component, and a retracted position wherein said supplemental protrusion is not received in said opening such that said protrusion does not couple said bound system to said component, and wherein said protrusion and said supplemental protrusion are configured to be received in opposite ends of said binding device.

24. A system including a component for use with a bound system including a binding mechanism with a generally axially-extending opening, the component including:
a body; and
a first and a second protrusion movably coupled to said body, each protrusion being movable between an engaged position wherein at least part of the associated protrusion is received in said opening of said binding mechanism to couple said bound system to said component, and a retracted position wherein the associated protrusion is not received in said opening.

25. The system of claim 24 further including the bound system including the binding mechanism with the generally axially-extending opening, wherein the first and second protrusions are received in opposite ends of the opening to couple the bound system to the component.
